(19) United States
(12) Patent Application Publication
(10) Pub. No.: US 2009/0204593 A1
(43) Pub. Date: Aug. 13, 2009

(54) System and method for parallel retrieval of data from a distributed database

(75) Inventors: Michael Bigby, San Jose, CA (US); Philip L. Bohannon, Cupertino, CA (US); Brian Cooper, San Jose, CA (US); Utkarsh Srivastava, Fremont, CA (US); Daniel Weaver, Redwood City, CA (US); Ramana V. Yerneni, Cupertino, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 12/069,486

(22) Filed: Feb. 11, 2008

(51) Int. Cl. G06F 7/06; G06F 17/30

(52) U.S. Cl. 707/4; 707/3; 707/E17.014; 707/E17.006

(57) ABSTRACT

An improved system and method for parallel retrieval of data from a distributed database is provided. A parallel interface may be provided for use by a cluster of client machine for parallel retrieval of partial results from parallel execution of a database query by a cluster of database servers storing a distributed database. A query interface may be augmented for inputting a database query and specifying the number of instances of parallel retrieval of results from query execution. To do so, a commercial query language may be augmented for sending a query request that may include a parameter specifying the database query and an additional parameter specifying the desired retrieval parallelism. The augmented query interface may return a list of retrieval point addresses for retrieving the partial results assigned to each of the retrieval point addresses from parallel execution of the database query.

### FIELD OF THE INVENTION

The invention relates generally to computer systems, and more particularly to an improved system and method for parallel retrieval of data from a distributed database.

### BACKGROUND OF THE INVENTION

Database systems usually provide only a very simple, sequential interface, referred to as cursors, for the client to retrieve data from them. For retrieval of massive amounts of data from a large-scale distributed database, sequential access for clients becomes an acute bottleneck. To overcome this limitation, applications requiring more scalability may manually create several client instances, each of which is made responsible for retrieving a separate disjoint partition of the data.

However, this creates a burden on application developers for several reasons. First, the data contents must be known beforehand for creating such partitions in the application. The application may be tailored to the data set by writing custom code to partition the query into pieces such that each piece returns a disjoint, equi-sized partition of the original query result. Second, it is very difficult for the application to ensure load balancing so that partitions may be of roughly equal-size. Moreover, these difficulties result in application-level code that is complex and highly customized to a particular dataset.

What is needed is a way for a cluster of client machines to be able to retrieve data at speeds much higher than currently possible by a serial interface to database systems. Such a system and method should require minimal effort by application builders and without the need to build applications customized for retrieving a particular dataset in order to transfer data at higher speeds.

### SUMMARY OF THE INVENTION

The present invention provides a system and method for parallel retrieval of data from a distributed database. A parallel interface may be provided for use by a cluster of client machines for parallel retrieval of partial results from parallel execution of a database query by a cluster of database servers storing a distributed database. A query interface may be augmented for inputting a database query and specifying the number of instances of parallel retrieval of results from query execution. For example, a commercial query language may be augmented for sending a query request that may include a parameter specifying the database query and an additional parameter specifying the desired retrieval parallelism. The augmented query interface may return a list of assigned retrieval point addresses at which partial results from parallel execution of the query can be retrieved.

A client may accordingly invoke the augmented query interface specifying the desired retrieval parallelism, and the query request specifying the number of instances of parallel retrieval of results may be sent to a database server for query execution. The client may receive a list of assigned retrieval point addresses returned for retrieving the partial results assigned to each of the retrieval point addresses from parallel execution of the database query. Several client machines networked together may be handed the query identifier and one or more of the retrieval point addresses. A query instance may be instantiated for each retrieval point address received by each client machine, and each query instance may invoke an augmented application programming interface to retrieve the partial result assigned to the retrieval point address.

A database server may receive the query request specifying the number of instances of parallel retrieval of results. The database server may then determine a query execution plan for parallel execution of the database query such that the partial results become available at the desired number of retrieval points. The list of assigned retrieval point addresses may then be returned to the client. Several database servers networked together to store the distributed database may each perform query processing for a partial query and assign a partial result of the database query to a retrieval point address. A request may then be received by each of the database servers for retrieving the partial result assigned to that retrieval point.

Thus, the present invention may provide a parallel interface to retrieve massive amounts of data from a large-scale distributed database. A cluster of client machines enabled with several parallel instances for data retrieval can then use the parallel interface to retrieve data at speeds much higher than currently possible, more reliably and robustly, and with very little application-building effort.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for parallel retrieval of data from a distributed database, in accordance with an aspect of the present invention;

FIG. 3 is a flowchart generally representing the steps undertaken in one embodiment for parallel retrieval of data from a distributed database, in accordance with an aspect of the present invention;

FIG. 4 is a flowchart generally representing the steps undertaken in one embodiment on a client for parallel retrieval of data from a distributed database, in accordance with an aspect of the present invention; and

FIG. 5 is a flowchart generally representing the steps undertaken in one embodiment on a database server for parallel retrieval of data from a distributed database, in accordance with an aspect of the present invention.

### DETAILED DESCRIPTION

### Exemplary Operating Environment

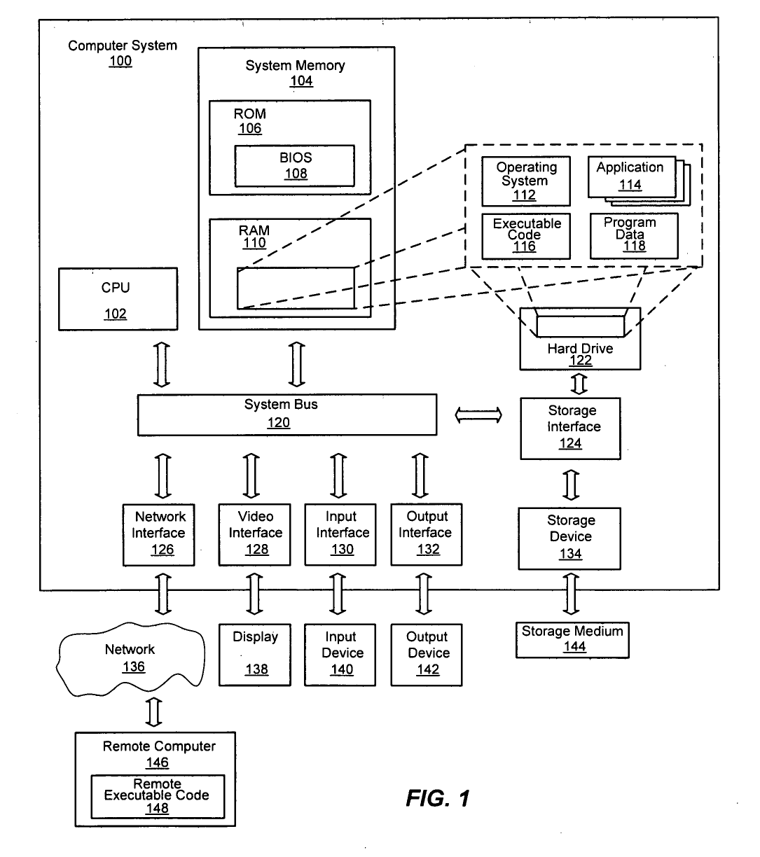

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Parallel Retrieval of Data from a Distributed Database

The present invention is generally directed towards a system and method for parallel retrieval of data from a distributed database. A cluster of client machines may use a parallel interface for parallel retrieval of partial results from parallel execution of a database query by a cluster of database servers storing a distributed database. A query interface may be augmented for inputting a database query and specifying the number of instances of parallel retrieval of results from query execution. A commercial query language may be augmented for sending a query request that may include a parameter specifying the database query and an additional parameter specifying the desired retrieval parallelism. The augmented query interface may return a list of assigned retrieval point addresses at which partial results from parallel execution of the query can be retrieved.

As will be seen, a cluster of client machines may use the parallel interface to retrieve massive amounts of data from a large-scale distributed database. As will be understood, the various block diagrams, flow charts and scenarios described herein are only examples, and there are many other scenarios to which the present invention will apply.

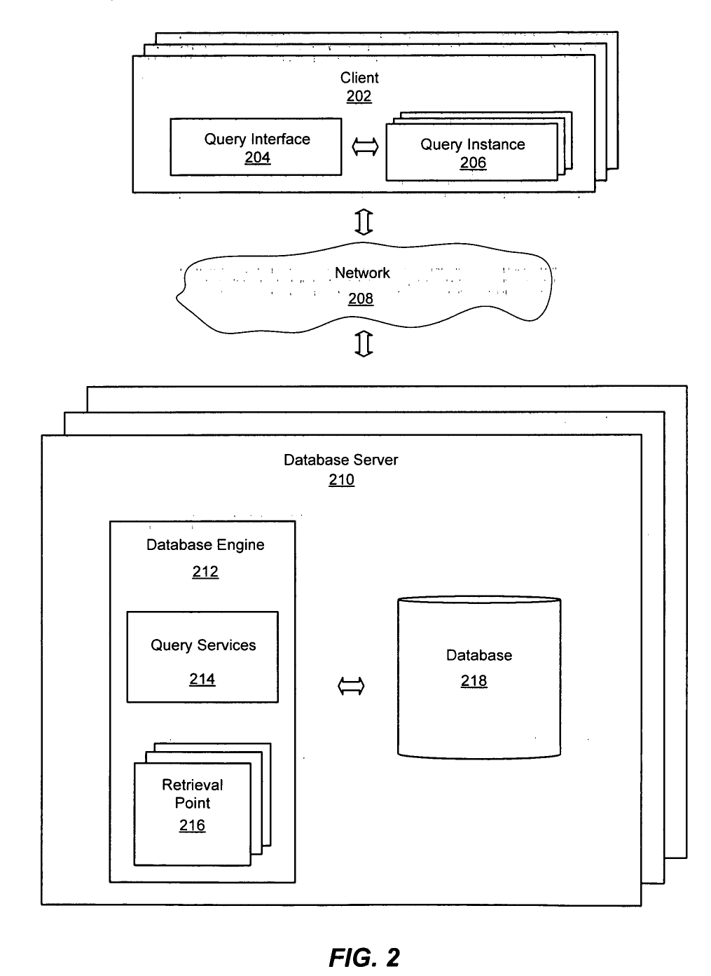

Turning to FIG. 2 of the drawings, there is shown a block diagram generally representing an exemplary architecture of system components for parallel retrieval of data from a distributed database. Those skilled in the art will appreciate that the functionality implemented within the blocks illustrated in the diagram may be implemented as separate components or the functionality of several or all of the blocks may be implemented within a single component. For example, the functionality for the query services 214 on the database server 210 may be implemented as a separate component from the database engine 210. Or the functionality for the query services 214 may be included in the same component as the database engine 210 as shown. Moreover, those skilled in the art will appreciate that the functionality implemented within the blocks illustrated in the diagram may be executed on a single computer or distributed across a plurality of computers for execution.

In various embodiments, several networked client computers 202 may be operably coupled to one or more database servers 210 by a network 208. Each client computer 202 may be a computer such as computer system 100 of FIG. 1. The network 208 may be any type of network such as a local area network (LAN), a wide area network (WAN), or other type of network. A query interface 204 may execute on the client computer 202 and may include functionality for receiving a database query which may be input by a user and for sending the database query to a database server 210 for processing the database query. The query interface 204 may specify the number of instances of parallel retrieval of results from query execution and may instantiate several query instances 206 executing in parallel on one or more client 202 machines for receiving partial query results. In general, the query interface 204 and query instances 206 may be any type of interpreted or executable software code such as a kernel component, an application program, a script, a linked library, an object with methods, and so forth.

The database servers 210 may be any type of computer system or computing device such as computer system 100 of FIG. 1. The database servers 210 may represent a large distributed database system of operably coupled database servers. In general, each database server 210 may provide services for performing semantic operations on data in the database 218 and may use lower-level file system services in carrying out these semantic operations. Each database server 210 may include a database engine 212 which may be responsible for communicating with a client 202, communicating with the database server 210 to satisfy client requests, accessing the database 218, and processing database queries. The database engine may include query services 214 for processing received queries by determining a query execution plan and returning a list of retrieval point addresses 216 for retrieving the partial results from parallel execution of the database query. Each of these modules may also be any type of executable software code such as a kernel component, an application program, a linked library, an object with methods, or other type of executable software code.

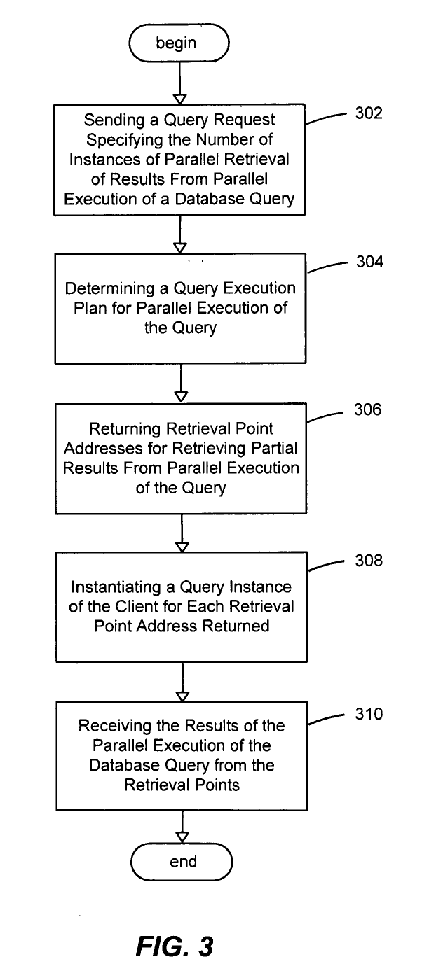

There are many applications which may use the present invention for faster database query processing times for a large distributed database. Data mining and online applications are examples among these many applications. FIG. 3 presents a flowchart for generally representing the steps undertaken in one embodiment for parallel retrieval of data from a distributed database. At step 302, a database query request may be sent specifying the number of instances of parallel retrieval of results from query execution. For example, a user or application may input a database query and input the number of instances of parallel retrieval of results from query execution using a commercial query language, such as ODBC, augmented to allow specification of desired retrieval parallelism. An ODBC query interface such as executeQuery (<SQL query>) may be augmented, for example, in an embodiment as follows:

executeQuery (<SQL query>, <desired retrieval parallelism>n).

The database query and the number of instances of parallel retrieval of results from query execution may then be sent by the query interface API to a database server for processing.

At step 304, a query execution plan may be determined for parallel execution of the database query. In an embodiment, a database server may receive the database query request specifying the number of instances of parallel retrieval of results and the query services of a database engine may determine a query execution plan and return a list of assigned retrieval point addresses for retrieving the partial results from parallel execution of the database query. In particular, the query services may partition the database query by generating several partial queries and assign retrieval point addresses for accumulating partial results from parallel execution of the database query. Each partial result of the partitioned database query may be assigned to a retrieval point address for retrieval.

Once a query execution plan may be determined for parallel execution of the database query, retrieval point addresses may be returned at step 306 for retrieving partial results from parallel execution of the database query. The augmented ODBC query interface, executeQuery (<SQL query>, <desired retrieval parallelism>n), is a method which may return a unique query identifier and a list of URLs as the retrieval point addresses. The database server may return the list of assigned retrieval point addresses to the query interface operating on the client machine for retrieving the result of the partial query assigned to each of the retrieval point addresses. At step 308, a query instance of the client may be instantiated for each retrieval point address returned. In an embodiment, a query instance may be instantiated by each networked machine handed the query identifier and one of the retrieval point addresses.

At step 310, the results from parallel execution of the database query may be received from retrieval points. In an embodiment, each query instance instantiated on a client machine may invoke an API of a commercial query language augmented to include a retrieval point address for retrieving the result of the partial query assigned to that retrieval point address. For example, a query interface of a client machine may request results of execution of a partial query from a retrieval point using a commercial query language, such as ODBC, augmented to include a retrieval point address for retrieving the result of the partial query assigned to that retrieval point address. An ODBC query interface such as retrieveResults (<query id>) may be augmented, for example, in an embodiment as follows:

retrieveResults (<query id>, <URL>).

Each query instance executing on the networked client machines may request results of execution of a partial query from a retrieval point using such an augmented API. In an embodiment, an implementation of the augmented API may bind to the given URL and retrieve the partial query result for the given query identifier.

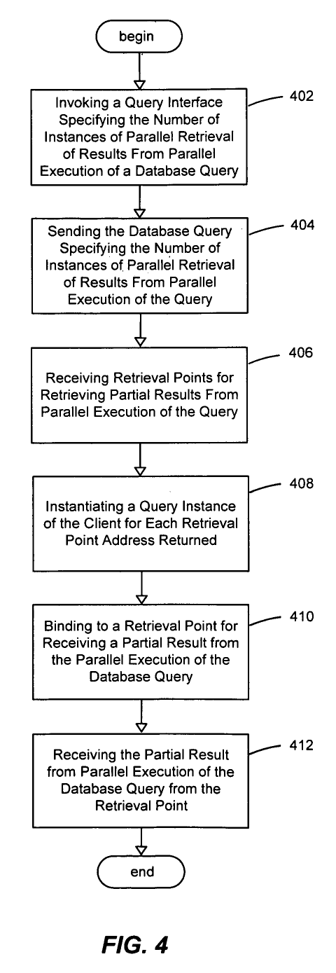

FIG. 4 presents a flowchart for generally representing the steps undertaken in one embodiment on a client for parallel retrieval of data from a distributed database. At step 402, a query interface specifying number of instances of parallel retrieval of results from query execution may be invoked. For example, an augmented ODBC query interface, such as executeQuery (<SQL query>, <desired retrieval parallelism>n), may be invoked by a user or application on a client machine. At step 404, the database query request specifying the number of instances of parallel retrieval of results from query execution may be sent to a distributed database. The augmented ODBC query interface, executeQuery (<SQL query>, <desired retrieval parallelism>n), is a method which may return a unique query identifier and a list of URLs as the retrieval point addresses. The database server may return the list of assigned retrieval point addresses to the query interface operating on the client machine for retrieving the result of the partial query assigned to each of the retrieval point addresses.

Accordingly, the retrieval points may be received at step 406 by the client for retrieving partial results from parallel execution of a database query. At step 408, a query instance of the client may be instantiated for each retrieval point address returned. In an embodiment, several networked client machines that may be part of the retrieval process are handed the query identifier and one of the retrieval point addresses. A query instance may be instantiated by each networked machine for retrieving the result of the partial query assigned to the retrieval point address received. In various embodiments, a networked client machine may be handed several retrieval point addresses and may instantiate a query instance for each retrieval point address received.

At step 410, a query instance executing on a client may bind to a retrieval point for receiving a partial result from the parallel execution of the database query. Each query instance executing on the networked client machines may request results of execution of a partial query from a retrieval point using such an augmented API as retrieveresults (<query id>, <URL>). An implementation of the augmented API may bind to the given URL and retrieve the partial query result for the given query identifier. And at step 412, the partial result from the parallel execution of the database query may be received from the retrieval point address by the query instance executing on a client.

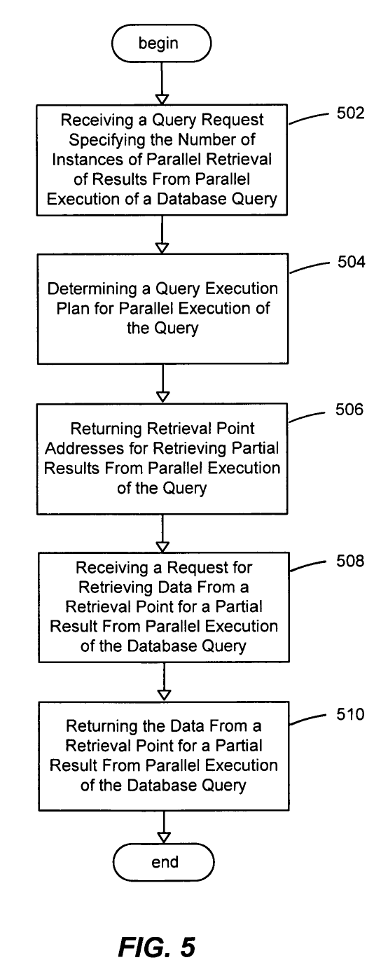

FIG. 5 presents a flowchart for generally representing the steps undertaken in one embodiment on a database server for parallel retrieval of data from a distributed database. At step 502, a database query request specifying the number of instances of parallel retrieval of results from query execution may be received by a database server, and a query execution plan may be determined at step 504 for parallel execution of the database query. The query services may partition the database query by generating several partial queries and assign retrieval point addresses for accumulating partial results from parallel execution of the database query. Each partial result of the partitioned database query may be assigned to a retrieval point address for retrieval. In general, several database servers networked together to store the distributed database may each perform query processing for a partial query and assign a partial result of the database query to a retrieval point address.

At step 506, a retrieval point address may be returned for each requested instance of retrieval parallelism. In an embodiment, there may be fewer retrieval point addresses returned than the number of instances of parallel retrieval requested. At step 508, a request may be received by the database server for retrieving data from a retrieval point address for a partial result from parallel execution of the database query, and the database server may return data at step 510 from the retrieval point address for the partial result from parallel execution of the database query.

Thus the present invention may provide a parallel interface to retrieve massive amounts of data from a large-scale distributed database. A cluster of client machines enabled with several parallel instances for data retrieval can use the parallel interface to retrieve data at speeds much higher than currently possible, more reliably and robustly, and with very little application-building effort. Importantly, the system and method scale well for increasing amounts of data stored in a distributed database system. In addition, the present invention may be used to transfer data from one database system to another without requiring the use of an intermediate file for loading the data.

As can be seen from the foregoing detailed description, the present invention provides an improved system and method for parallel retrieval of data from a distributed database. A client may invoke an augmented query interface specifying a desired retrieval parallelism, and the client may receive a list of assigned retrieval point addresses returned for retrieving the partial results from parallel execution of the database query. A query instance may be instantiated for each retrieval point address received by several client machines networked together, and each query instance may invoke an augmented application programming interface to retrieve the partial result assigned to the retrieval point address. An application may use the present invention for parallel retrieval without performing data partitioning and load balancing at the application level. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A distributed computer system for query processing, comprising:
a plurality of client computers operably coupled to provide a parallel interface for retrieving data from a plurality, of retrieval point addresses of a distributed database stored across a plurality of database servers;
a query interface operably coupled to at least one of the plurality of client computers having an application programming interface for invoking a database query request specifying a number of instances of parallel retrieval of results from parallel execution of the database query request; and
a plurality of query instances operably coupled to at least one of the plurality of client computers for retrieving partial results of the database query processed in parallel by a plurality of database servers.

2. The system of claim 1 further comprising at least one database server operably coupled to the plurality of client computers for returning the plurality of retrieval point addresses of the distributed database stored across a plurality of database servers to the at least one of the plurality of client computers having the application programming interface for invoking the database query request specifying the number of instances of parallel retrieval of results from parallel execution of the database query request.

3. The system of claim 1 further comprising a database engine operably coupled to the at least one database server for determining the plurality of retrieval point addresses of the distributed database for retrieving the data.

4. The system of claim 3 further comprising query services operably coupled to the database engine for determining a query execution plan for returning a list of assigned retrieval point addresses for retrieving the partial results from parallel execution of the database query.

5. A computer-readable medium having computer-executable components comprising the system of claim 1.

6. A computer-implemented method for query processing, comprising:
receiving a query identifier and at least one retrieval point address of a database server for retrieving a partial result from parallel execution of a database query;
requesting the partial result from parallel execution of the database query by invoking an application programming interface specifying the query identifier and the at least one retrieval point address; and
receiving from the at least one retrieval point address the partial result from parallel execution of the database query.

7. The method of claim 6 further comprising invoking an application programming interface for specifying the database query and specifying a plurality of instances of parallel retrieval of results from parallel execution of the database query.

8. The method of claim 6 further comprising sending a database query request specifying a plurality of instances of parallel retrieval of results from parallel execution of the database query to a distributed database for query processing.

9. The method of claim 6 further comprising instantiating a query instance for requesting the partial result from parallel execution of the database query by invoking an application programming interface specifying the query identifier and the at least one retrieval point address.

10. The method of claim 6 further comprising binding to the at least one retrieval point address of the database server for retrieving the partial result from parallel execution of the database query.

11. The method of claim 6 further comprising receiving the database query request specifying the plurality of instances of parallel retrieval of results from parallel execution of the database query for query processing.

12. The method of claim 6 further comprising determining a query execution plan for parallel execution of the database query.

13. The method of claim 6 further comprising returning the query identifier and the at least one retrieval point address of the database server for retrieving the partial result from parallel execution of the database query.

14. The method of claim 6 further comprising receiving a request specifying the query identifier and the at least one retrieval point address for retrieving the partial result from parallel execution of the database query.

15. The method of claim 6 further comprising returning from the at least one retrieval point address the partial result from parallel execution of the database query.

16. A computer-readable medium having computer-executable instructions for performing the method of claim 6.

17. A distributed computer system for query processing, comprising:
means for receiving a database query request specifying a plurality of instances of parallel retrieval of results from query execution;
means for determining a query execution plan for parallel execution of the database query request;
means for returning a plurality of retrieval point addresses of at least one database server for retrieving a plurality of partial results from parallel execution of the database query; and
means for sending from at least one retrieval point address a partial result from parallel execution of the database query.

18. The computer system of claim 17 further comprising means for sending the database query request specifying the plurality of instances of parallel retrieval of results from query execution.

19. The computer system of claim 17 further comprising means for receiving a query identifier and a plurality of retrieval point addresses of the at least one database server for retrieving the plurality of partial results from parallel execution of the database query.

20. The computer system of claim 17 further comprising:
means for receiving a query identifier and at least one retrieval point address of the at least one database server for retrieving the partial result from parallel execution of the database query;
means for requesting the partial result from parallel execution of the database query by invoking an application programming interface specifying the query identifier and the at least one retrieval point address; and
means for receiving from the at least one retrieval point address the partial result from parallel execution of the database query.
